(19) United States
(12) Patent Application Publication
(10) Pub. No.: US 2019/0116861 A1
(43) Pub. Date: Apr. 25, 2019

(54) Clips for connecting gingerbread components of gingerbread structures

(71) Applicant: BRAND CASTLE LLC, Bedford Heights, OH (US)

(72) Inventor: James E. Zeilinger, Shaker Heights, OH (US)

(21) Appl. No.: 15/998,352

(22) Filed: Aug. 6, 2018

Related U.S. Application Data
(63) Continuation-in-part of application No. 29/651,013, filed on Oct. 20, 2017.
Application No. 29/651,013 is a continuation-in-part of application No. 29/651,014, filed on Oct. 20, 2017.
Application No. 29/651,014 is a continuation-in-part of application No. 29/651,380, filed on Jun. 28, 2018.
Application No. 29/651,380 is a continuation-in-part of application No. 29/651,381, filed on Jun. 28, 2018.
Application No. 29/651,380 is a continuation-in-part of application No. 29/651,012, filed on Oct. 20, 2017.
Application No. 29/651,012 is a continuation-in-part of application No. 15/914,727, filed on Mar. 7, 2018.
Application No. 29/651,381 is a continuation-in-part of application No. 29/651,012, filed on Oct. 20, 2017.
Application No. 29/651,012 is a continuation-in-part of application No. 15/914,727, filed on Mar. 7, 2018.
(60) Provisional application No. 62/707,074, filed on Oct. 20, 2017.

(51) Int. Cl. A23P 10/10; A23G 3/56

(52) U.S. Cl. CPC A23P 10/10; A21D 13/48; A23G 3/56

(57) ABSTRACT

Substantially rigid clips are disclosed that are configured to engage, to connect, to underlie, to overlie, to grip, and/or to assist in holding in desired assembled orientation selected gingerbread components of gingerbread structures—as well as gingerbread structures that are built using one or more of, or sets of, the substantially rigid clips. Methods of assembly of gingerbread structures are disclosed, as well as a bridging clip that has substantially identical opposed end regions connected by an elongate central region.

### CROSS-REFERENCE TO RELATED APPLICATIONS

This application is a continuation-in-part of Utility application Ser. No. 15/914,727 entitled ERECTING GINGERBREAD STRUCTURES USING CLIPS ASSISTING TO CONNECT ADJACENT GINGERBREAD COMPONENTS, filed by James E. Zeilinger on Mar. 7, 2018, Atty's Dkt. No. 7-539.

Utility application Ser. No. 15/914,727 identified just above claims the benefit of the filing date of Provisional Application Ser. No. 62/707,074 entitled METHOD OF ERECTING GINGERBREAD STRUCTURES USING CLIPS ASSISTING TO CONNECT ADJACENT GINGERBREAD COMPONENTS, filed by James E. Zeilinger on Oct. 20, 2017, Atty's Dkt. No. 7-535.

The present application is also a continuation-in-part of the following five design applications, namely:

1) Design application Serial No. 29/651,012 filed Oct. 20, 2017 by James E. Zeilinger entitled ROOF SUPPORT CLIP THAT FACILITATES THE ERECTION OF GINGERBREAD HOUSES AND BUILDINGS, Atty's Dkt. No. 7-537;

2) Design application Serial No. 29/651,013 filed Oct. 20, 2017 by James E. Zeilinger entitled BASE CLIP THAT FACILITATES THE ERECTION OF GINGERBREAD HOUSES AND BUILDINGS, Atty's Dkt. No. 7-538;

3) Design application Serial No. 29/651,014 filed Oct. 20, 2017 by James E. Zeilinger entitled SET OF CLIPS THAT FACILITATE THE ERECTION OF GINGERBREAD HOUSES AND BUILDINGS, Atty's Dkt. No. 7-536;

4) Design application Serial No. 29/651.380 filed Jun. 28, 2018 by James E. Zeilinger entitled ROOF SUPPORT CLIP FOR GINGERBREAD HOUSES AND BUILDINGS, Atty's Dkt. No. 7-637; and

5) Design application Serial No. 29/651,381 filed Jun. 28, 2018 by James E. Zeilinger entitled WALL BRIDGING AND ROOF SUPPORT CLIP FOR GINGERBREAD HOUSES AND BUILDINGS, Atty's Dkt. No. 7-634.

The disclosures of each of the above-listed earlier-filed design, utility and provisional applications are incorporated herein by reference, in their entireties.

### FIELD OF THE INVENTION

In one respect, the present invention relates to the construction of gingerbread houses and buildings formed from baked gingerbread components typically including both upstanding wall components, and roof components that overlie selected portions of some of the upstanding wall components.

In another respect, the present invention relates to the provision and use of substantially rigid clips, and sets of clips, that are configured to engage, to connect, to grip, to underlie, to overlie and/or to assist in holding in desired assembled orientation selected gingerbread components of gingerbread structures.

In yet another respect, the present invention relates to substantially rigid clips, and sets of clips, that differ from some of the substantially rigid clips disclosed in the aforementioned design, utility and provisional applications.

One of the new substantially rigid clips disclosed herein has substantially identically configured opposed end regions connected by an elongate central region that can bridge between two spaced-apart, upstanding gingerbread wall components of a gingerbread structure.

### BACKGROUND

It has long been known to construct building-like structures from substantially flat pieces of baked gingerbread that form upstanding wall components and overlying roof components of the building-like structures.

Many of these building-like gingerbread structures have deposits of icing, or lines of icing, that are intended to bond joints that extend between adjacent gingerbread components of assembled gingerbread structures.

A long-standing problem associated with the construction of baked gingerbread structures of the type just described has been a weakness of the deposits or lines of, icing that are used to bond adjacent gingerbread components of the gingerbread structures, and/or to help retain gingerbread components in desired assembled orientations.

Another long-standing problem has been a tendency of spaced-apart gingerbread components of gingerbread structures to bend or bulge relatively to each other, whereas the spaced-apart components are meant to extend substantially parallel to each other without bending or bulging along certain lengths of such components.

A more effective means other than the use of mere deposits or lines of icing has long been needed to connect, bond and support both adjacent and non-adjacent gingerbread components of gingerbread structures. The aforementioned utility application Ser. No. 15/914,727 addresses at least a portion of this need by providing substantially rigid clips, and sets of these clips, that can be used to help retain gingerbread components of assembled gingerbread structures in desired relative relationships.

### SUMMARY OF THE INVENTION

Just as does the invention disclosed in referenced utility application Ser. No. 15/914,727, the present invention provides and utilizes substantially rigid clips, and sets of these clips, to engage, to connect, to underlie, to overlie and/or to assist in holding in desired assembled orientation gingerbread components of gingerbread structures.

The present invention provides and calls for the use of substantially rigid clips to assist in holding gingerbread components in desired assembled orientations, wherein the gingerbread components being held in desired assembled orientations are not necessarily adjacent to each other.

The present invention also provides and uses improved forms of roof support clips, with some of these improved clips also being configured to bridge between, to grip, and to hold in spaced parallel-extending relationship pairs of upstanding wall components of gingerbread structures—not only while these gingerbread structures are being erected, but also after the structures have been assembled.

If the clips that are used during the erection of a gingerbread house or building are all formed from substantially rigid hard candy such as that used in making candy canes and the like, all of the clips, together with any icing that is used to bond adjacent gingerbread components, and the baked gingerbread components themselves are edible.

### BRIEF DESCRIPTION OF THE DRAWINGS

FIG. 1 is a perspective view showing a basic set of six relatively stiff clips that can be used in constructing a substantially rectangular gingerbread structure such as is shown in FIG. 20;

FIG. 2 is a top, front and left side perspective view of one of four identical base clips that are preferably included in the basic set of clips shown in FIG. 1, which clip can also be used by itself or in combination with other forms of substantially rigid clips in gingerbread structures;

FIG. 3 is a front view thereof;

FIG. 4 is a rear view thereof;

FIG. 5 is a top view thereof;

FIG. 6 is a bottom view thereof;

FIG. 7 is a left side view thereof, it being understood that a right side view thereof is a mirror image hereof;

FIG. 8 is a top, front and left side perspective view of one of two identical improved roof support clips that are preferably included in the basic set of clips shown in FIG. 1, which clip can also be used by itself or in combination with other forms of substantially rigid clips in gingerbread structures;

FIG. 9 is a front view thereof;

FIG. 10 is a rear view thereof;

FIG. 11 is a top view thereof;

FIG. 12 is a bottom view thereof;

FIG. 13 is a left side view thereof, it being understood that a right side view thereof is a mirror image hereof;

FIG. 14 is an elevational view, on a smaller scale, showing the configuration of a basic set of six baked gingerbread components of substantially uniform thickness that preferably are used in constructing the gingerbread structure shown in FIG. 20, with the set of components including identical first and second five-sided upstandiny end wall components, identical first and second rectangular upstanding sidewall components, and identical first and second rectangular roof components;

FIG. 15 is a schematic view showing (by means of a curved arrow) how the first end wall component is moved to an assembled position where opposite end regions of a bottom edge thereof has been inserted into aligned, upwardly opening channels defined by a first pair of the four base clips, with each of the four base clips being depicted in a location where one of four corner regions of the house-like structure shown in FIG. 20 eventually will be located;

FIG. 16 is a perspective view showing a bottom edge of the first end wall component inserted into aligned, upwardly opening channels of the first pair of the base clips, with the view also showing new lines of icing applied to opposite upstanding end regions of an interior surface of the first upstanding end wall component at locations where the first and second sidewall components will be moved to assembled positions to bond with the first upstanding end wall component, it being noted that in FIGS. 16-20 broken lead lines point to hidden channels 27 and 28 of the base clips 20;

FIG. 17 is a perspective view showing the interior surface of the first upstanding end wall component at a time after the two upstanding sidewall components have bottom edge portions thereof inserted into aligned, upwardly opening channels of a second pair of the depicted base clips, with new lines of icing applied to two upstanding edges of the first and second sidewall components so the new lines of icing will be engaged by opposite end regions of the interior surface of the second upstanding end wall component when the second end wall component is moved to its assembled position shown in FIG. 18;

FIG. 18 is a perspective view showing a more completely assembled version of the structure of FIG. 20 at a time after the second upstanding five-sided end wall component has been moved to its assembled position where opposite end regions of the bottom edge of the second upstanding end wall component are inserted into aligned channels of the second pair of base clips, with the assembled position also causing the second upstanding end wall component to become bonded to the first and second upstanding sidewall components by the new lines of icing that have been applied to the upstanding edges of the two sidewall components, as shown in FIG. 17;

FIG. 19 is a perspective view showing two new lines of icing that have been applied to parallel-extending, inclined upper edges of the first and second end wall components, with the view also showing how one of the two improved roof support clips has been installed to grip an uppermost edge region of a first one of the upstanding sidewall components, with a support arm of the roof support clip extending outwardly away from an exterior surface of the gripped sidewall component for underlying a lower edge region of a first of the rectangular roof components when moved to its assembled position shown in FIG. 20;

FIG. 20 is a perspective view showing the completed gingerbread structure after the first and second gingerbread roof components have been moved to their assembled positions atop lines of icing that have been applied to inclined upper edge regions of the first and second end wall components, and after a second of the improved roof support clips (not shown) has been installed to grip an upper edge region of the second sidewall component in the manner that the first roof support clip was installed to grip upper edge region of the first sidewall component (as shown in FIG. 19) to supportively underlie the lower edge of the second roof component, with FIG. 20 showing an upper edge region of one of the roof components being broken away so that an optional line of icing can be seen added within a trough defined by upper edges of the first and second roof components;

FIG. 21 is a top, front and right end perspective view showing an elongate wall-bridging roof support clip that can be used to bridge transversely between a pair of spaced-apart upstanding sidewall components to assist the sidewall components to maintain their parallel-extending relationship without bending or bulging relative to each other not only as a gingerbread structure is being erected, but also after the gingerbread structure has been built;

FIG. 22 is a right end view thereof, on an enlarged scale;

FIG. 23 is a cross-sectional view, on the same enlarged scale as FIG. 22, as seen from a plane indicated by a line 23-23.

FIG. 24 is a front view thereof;

FIG. 25 is a top view thereof;

FIG. 26 is a bottom view thereof;

FIG. 27 is a perspective view similar to FIGS. 18 and 19, showing the use of an elongate clip of the type shown in FIGS. 21-26 positioned to bridge between spaced-apart upstanding walls of a gingerbread structure being built, with the view also showing that roof support clips of the type shown in FIGS. 8-13 can also be used in combination with the elongate clip of FIGS. 21-26 to underlie and support edge regions of such gingerbread roof components as may be added to the gingerbread structure being built; and

FIG. 28 is a perspective view similar to FIG. 27 illustrating that more than one of the elongate clips of the type shown in FIGS. 21-26 can be used to bridge between spaced-apart components of a gingerbread structure.

### DETAILED DESCRIPTION

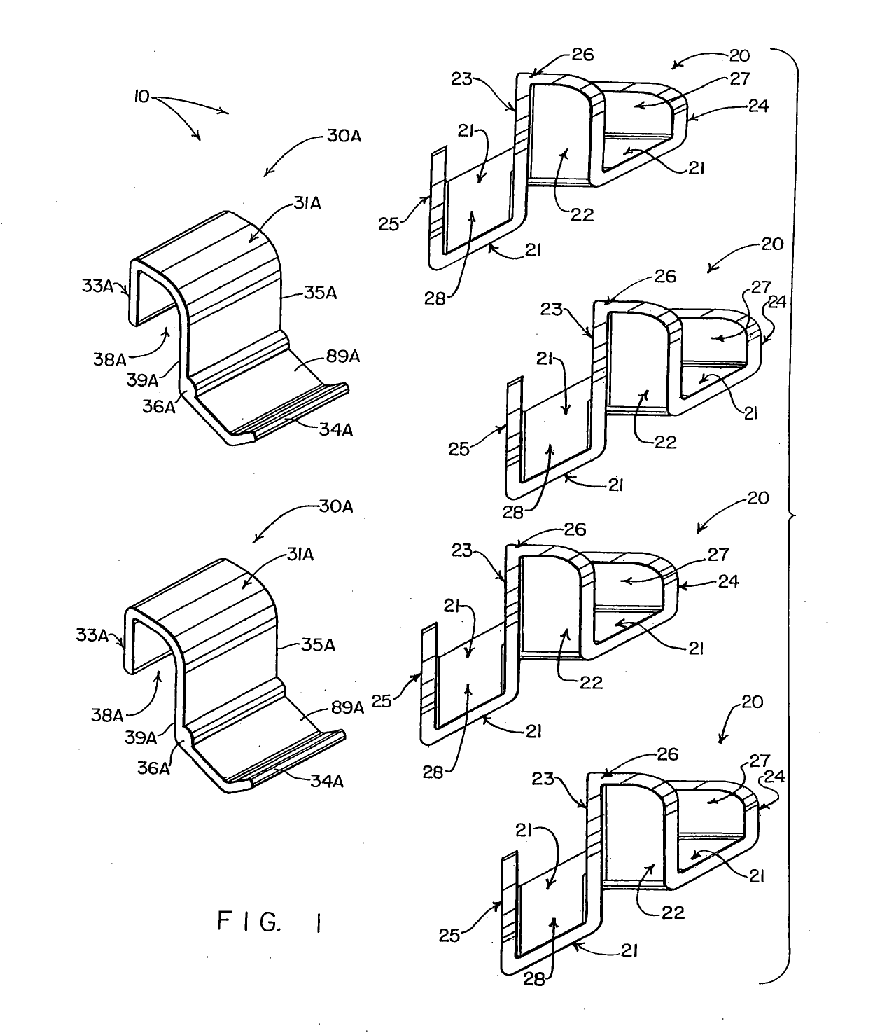

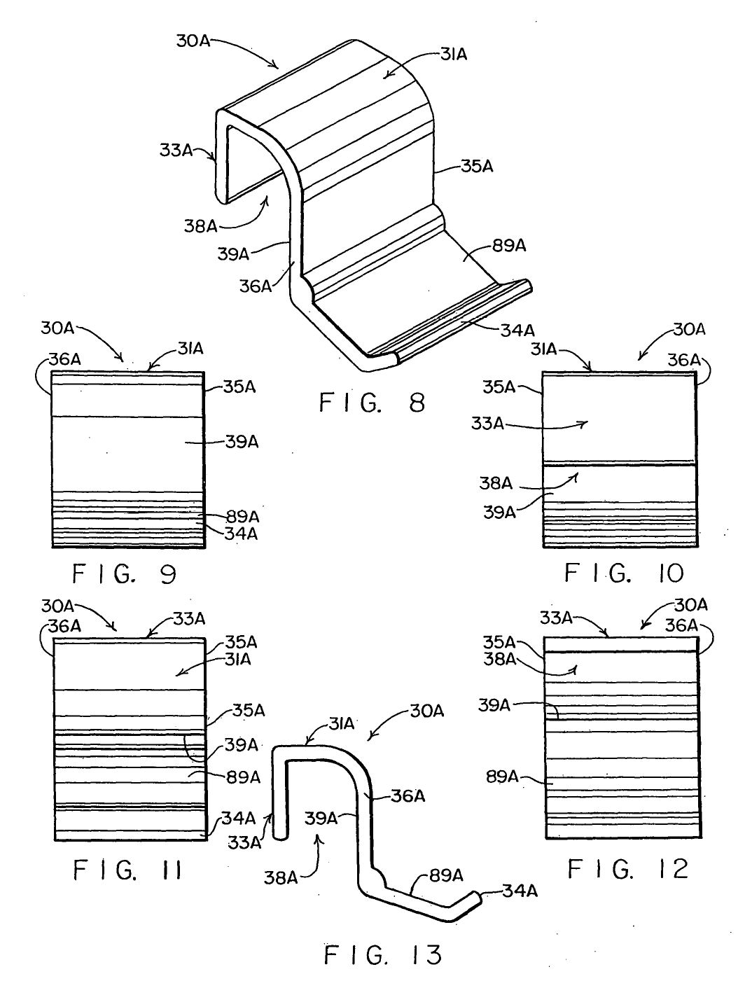

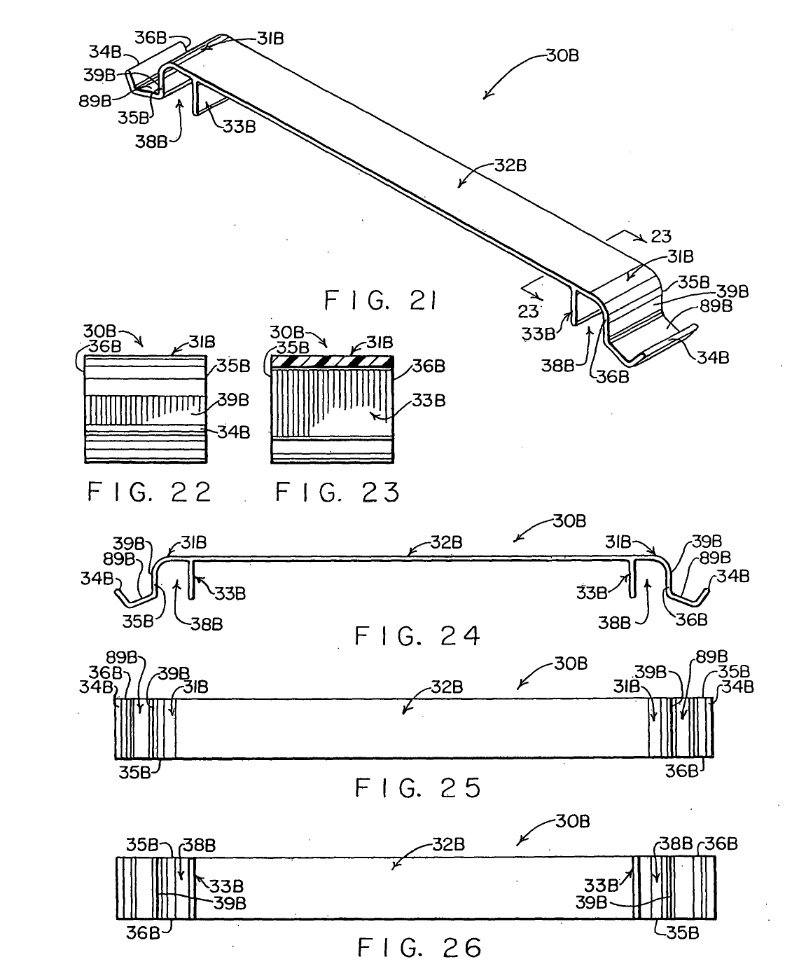

This application discloses not only an improved set of substantially rigid clips shown in FIG. 1, but also an improved form of substantially rigid roof support clip shown in FIGS. 8-13, as well as a new, substantially rigid bridging clip that is shown in FIGS. 21-26.

It will be understood that either, or both of, the substantially rigid clips depicted in FIGS. 8-13 and in FIGS. 21-26 of the present application can be used alone, or in combination with other substantially rigid clips—including the substantially rigid clips that are disclosed and depicted in the drawings of the aforementioned design, utility and provisional applications—to engage, to connect, to underlie, to overlie, to grip, and/or to assist in holding in desired assembled orientation selected gingerbread components of gingerbread structures.

It will also be understood that sets of substantially rigid clips such as are disclosed herein, and in the aforementioned design, utility and provisional applications, can be provided and used to engage, to connect, to underlie, to overlie, to grip, and/or to assist in retaining in desired assembled orientation selected gingerbread components of gingerbread structures. Such sets may include any of, and various combinations of, the substantially rigid clips depicted in any of the drawings of the present application, and/or in any of the drawings of the aforementioned design, utility and provisional applications.

It should also be understood that such clips as are disclosed in the present application and in the aforementioned design, utility and provisional applications can be used alone, or in combination, or in a variety of sets, to retain gingerbread components of gingerbread structures in desired assembled orientations—regardless of whether the gingerbread components that are retained in desired assembled orientations are adjacent to, or are spaced from each other, with said spaced-apart components also being referred to herein as “non-adjacent components.”

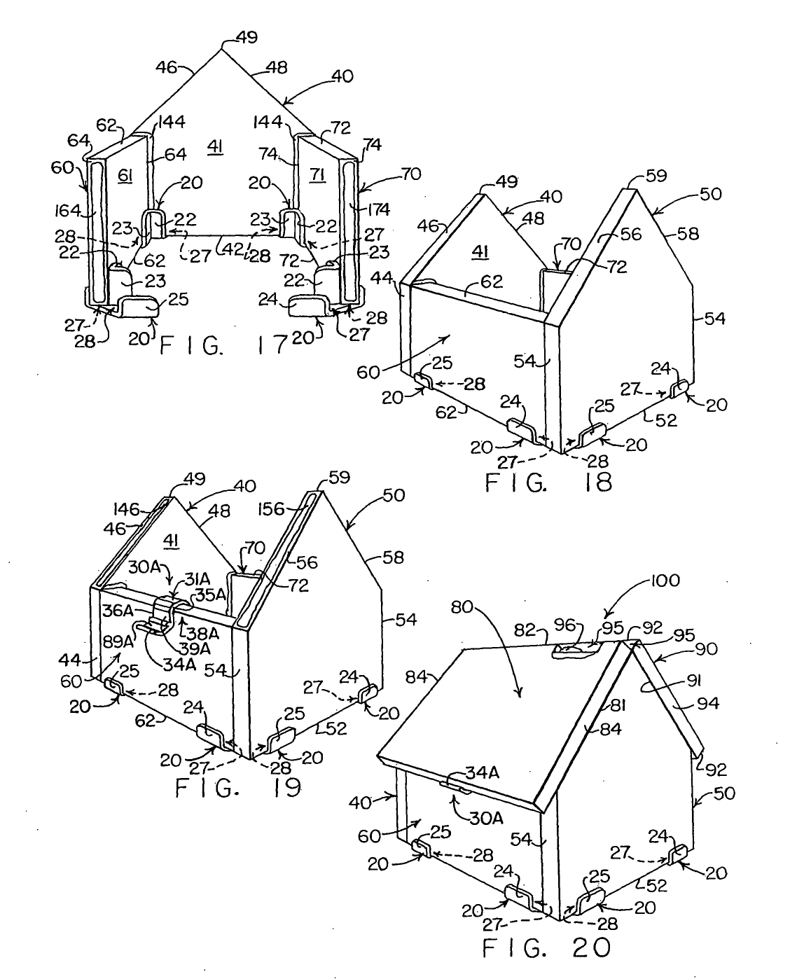

Referring to FIG. 1, a set of six substantially rigid clips, indicated generally by the numeral 10, embodies one aspect of the present invention. Other aspects of the present invention include methods of building gingerbread structures utilizing the set of, or similar sets of, the substantially rigid clips that are disclosed in the present application, or in any of the aforementioned design, utility and provisional applications—during the building of various gingerbread structures typified by the structure indicated by the numeral 100 in FIG. 20.

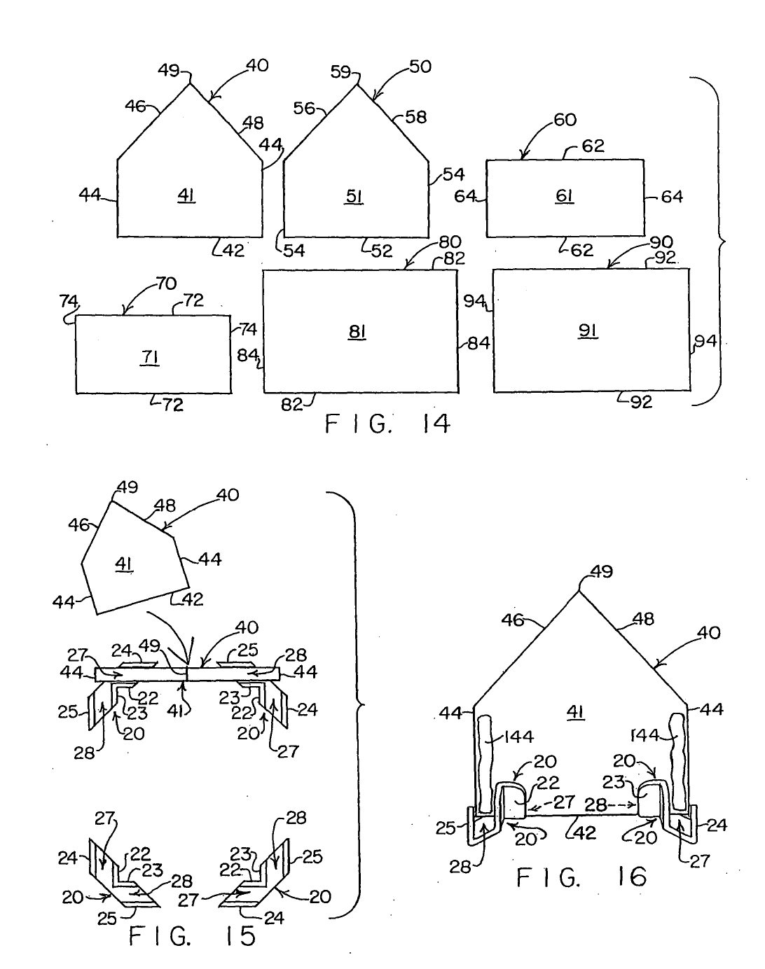

A typical set of steps used during the building of the structure 100 is illustrated by the sequence of views provided by FIGS. 15-20.

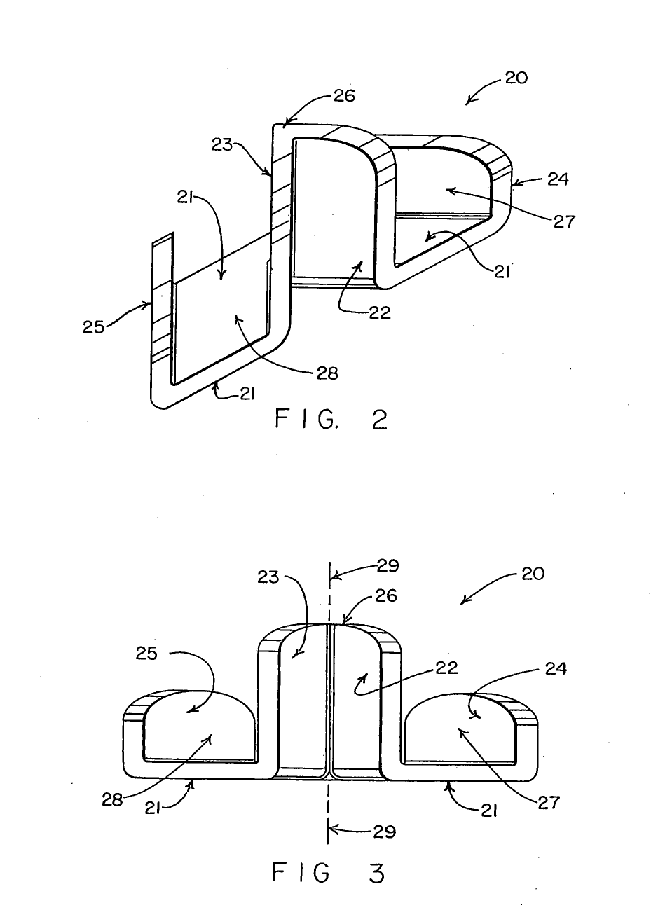

Referring again to FIG. 1, the set of substantially rigid clips 10 includes four identical base clips 20 (that also are shown in FIGS. 2-7), and two identical roof support clips 30A (that also are shown in FIGS. 8-13).

As this detailed description progresses, it will become apparent that, in several ways, not only the base clips 20, but also the completed gingerbread structure 100 exhibit a significant degree of symmetry, as will now be explained.

Insofar as the completed gingerbread structure 100 (shown in FIG. 20) is concerned, the structure 100 has “dual symmetry” in that left and right halves of the structure 100 are symmetrical (in that the left and right halves are mirror images of each other), and the front and rear halves of the structure 100 also are symmetrical (in that they, too, are mirror images of each other).

This “dual symmetry” of the structure 100 means that, as the construction of the structure 100 progresses, what takes place during the assembly of a first end region of the structure 100 (where the first end wall component 40 is located), will also take place during the assembly of the second end region of the structure 100 (where the second end wall component 50 is located); and, likewise, what takes place during the assembly of a left side of the structure 100 (where the first sidewall component 60 is located), will also take place during the assembly of the right side of the structure 100 (where the second sidewall component 70 is located).

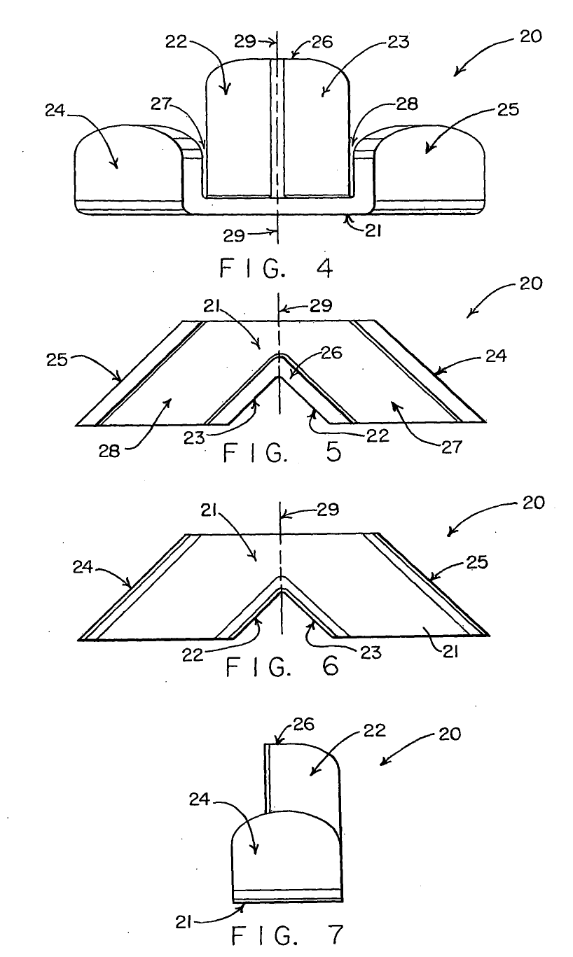

Insofar as the symmetry of the base clips 20 (shown in FIGS. 1-7) is concerned, each of the base clips 20 has right and left sides that are symmetrical about a centerline 29 that can be seen in the front view of FIG. 3, the rear view of FIG. 4, the top view of FIG. 5, and the bottom view of FIG. 6.

Referring to the top view provided by FIG. 5, it can be seen that each of the identical base clips 20 has a pair of upwardly opening, oppositely inclined, channels 27, 28—with the right channel 27 being a mirror image of the left channel 28. The channels 27, 28 are of generally U-shaped cross-section, with the upwardly opening U-shaped channel 27 having its opposite sides defined by a pair of upwardly extending, uniformly spaced, wall elements 22 and 24; and, with the upwardly opening U-shaped channel 28 having its opposite sides defined by a pair of upwardly extending, uniformly spaced, wall elements 23 and 25.

Unlike the symmetry exhibited by each of the base clips 20, the roof support clips 30A exhibit no symmetry whatsoever. Referring to FIGS. 1, 8 and 13, each of the roof support clips 30A has a right side 35A and a left side 36A, as well as a topmost surface 31A, a rearmost wall 33A, and a frontmost surface 34A.

As can best be seen in FIGS. 1, 8 and 13, a downwardly opening U-shaped channel 38A is defined between the rearmost wall 33A and a complexly curved central wall 39A of each of the roof support clips 30A. Each of the roof support clips 30A also has a forwardly-extending, upwardly-turned support arm 89A that reaches from the curved wall 39A to the forwardmost surface 34A.

A common dimensional characteristic shared by the base clips 20 and the roof support clips resides in a uniform width of the upwardly opening U-shaped channels 27, 28 of the base clips 20, and of the downwardly opening U-shaped channels 38A of the roof support clips 30A. This common dimensional width of the U-shaped channels 27, 28 and 38A is selected to render each of the U-shaped channels 27, 28 and 38A capable of receiving and securely gripping any of the edge regions of the preferably uniformly thick baked gingerbread components that are shown in FIG. 14.

Shown in FIG. 14 is a set of six baked gingerbread components that are indicated by the numerals 40, 50, 60, 70, 80 and 90. The components 40, 50, 60, 70, 80 and 90 comprise a set of substantially flat, substantially equally thick, baked gingerbread components of the type that preferably are used in the construction of such gingerbread structures as the house-like or building-like structure 100 shown in FIG. 20.

The baked gingerbread components 40, 50, 60, 70, 80 and 90 have what will be referred to as “interior surfaces” that are indicated in FIG. 14 by the numerals 41, 51, 61, 71, 81 and 91, respectively. As this detailed description of the construction of the structure 100 progresses, it will become clear that the gingerbread components 40, 50, 60, 70, 80 and 90 are moved to desired assembled orientations or positions that cause the interior surfaces 41, 51, 61, 71, 81 and 91, respectively, to all face toward the interior of the structure 100.

Referring again to FIG. 14, the identical pair of gingerbread components 40 and 50 are five-sided first and second upstanding end wall components that help to define the identical first and second end regions of the completed structure 100. The identical pair of gingerbread components 60 and 70 are rectangular first and second upstanding sidewall components that extend between and connect the first and second upstanding end wall components 40 and 50, respectively, of the structure 100. The identical pair of gingerbread components are 80 and 90 are rectangular first and second inclined roof components that cooperate to overlie the upstanding components 40, 50, 60 and 70 to form a gable roof of the structure 100.

The first and second end wall components 40, 50 have bottom edges 42, 52, respectively, as well as opposed upstanding edges 44, 54, respectively, and oppositely inclined, upper edges 46,48 and 56,58, respectively, that extend upwardly to peak points 49 and 59, respectively.

The first and second upstanding sidewall components 60, 70 have opposed bottom and top edges 62, 72, respectively, and opposite upstanding side edges 64, 74, respectively.

The first and second inclined roof components 80, 90 have opposed bottom and top edges 82, 92, respectively, and opposite upstanding side edges 84, 94, respectively.

Having described the base clips 20, the roof support clips 30A as well as the baked gingerbread components 40, 50, 60, 70, 80 and 90, reference is now made to FIGS. 15-20 which depict, somewhat schematically, the steps of a method by which the typical gingerbread structure 100 shown in FIG. 20 can be built, assembled or constructed.

As is shown in the lower two-thirds of FIG. 15, construction of the structure 100 is preferably begun by arranging the four identical base clips 20 (of the clip set 10 shown in FIG. 1) in a rectangular array, with each of the base clips 20 being positioned where a different one of the four corners of the completed structure 100 will eventually reside. The uppermost pair of the base clips 20 (in the rectangular array shown in FIG. 15) will be referred to as a first pair of the base clips 20; and, the lowermost pair of the base clips 20 will be referred to as a second pair of the base clips 20.

A curved arrow is provided in FIG. 15 to indicate how the first upstanding end wall component 40 (shown in an upper portion of FIG. 15) is moved to an assembled position (shown in the lower portion of FIG. 15), by causing opposite end regions of the bottom edge 42 of the first upstanding end wall component 40 to be inserted into two aligned, upwardly opening channels 27, 28 of the first pair of the four base clips 20.

Because many of the upwardly opening channels 27 and 28 of the base clips 20 that are shown in FIGS. 16-20 are hidden from view, broken lead lines (comprised of a series of dash marks) have been used in FIGS. 16-20 to point to where these hidden channels 27 and 28 are located.

A next step of constructing the structure 100 is shown in FIG. 16 where it can be seen that parallel-extending lines of icing 144 have been applied to opposite upstanding end regions of the interior surface 41 of the first end wall component 40 at locations where the lines of icing 144 will be engaged by upstanding edges 64, 74 of the first and second sidewall components 60, 70, respectively, to form elongate corner joints of the structure 100 when the first and second sidewall components 60, 70 are moved to their desired assembled orientations or positions shown in FIG. 17.

A next assembly step is shown in FIG. 17 where it can be seen that the upstanding edges 64, 74 of the first and second sidewall components 60, 70, respectively, have been pressed into the lines of icing 144, as lower portions of the two sidewall components 60, 70 have been pressed into the two remaining, upwardly-opening channels 27 and 28 of the same pair of the base clips 20 into which opposite upstanding edges 44 of the first end wall component 40 have already been inserted (as is shown in FIGS. 15 and 16).

As the upstanding edges 64, 74 of the sidewall components 60, 70, respectively, engage and are pressed against the lines of icing 144, the first and second sidewall components 60, 70 become bonded to the first upstanding end wall component 40. As the lines of icing 144 dry, set up or harden, the bonds between the sidewall components 60, 70 and the first endwall component 50 strengthen.

In FIG. 17, new lines of icing 164 and 174 are also shown that have been applied to upstanding edges 64 and 74 of the first and second sidewall components 60 and 70, respectively. When the second end wall component 50 is moved into its assembled position (shown in FIG. 18) to thereby be added to the structure 100 that is being formed, the lines of icing 164, 174 are engaged by opposite end regions of the interior surface 51 of the second end wall component 50, which causes the second end wall component 50 to become bonded to the first and second sidewall components 60, 70, just as the lines of icing 144 applied to opposite end regions of the interior surface 41 of the first end wall component 40 have caused the first and second sidewall components 60, 70 to become bonded to the first end wall component 40.

FIG. 18 shows that, when the second upstanding end wall component 50 is moved to its assembled position, opposite end regions of the bottom edge 52 of the second upstanding end wall component 40 have been inserted into aligned channels 27, 28 of the second pair of base clips 20, in the same manner that opposite end regions of the bottom edge 42 of the first upstanding end wall component 50 have been inserted into aligned channels 27, 28 of the first pair of base clips 20.

FIG. 19 shows the partially assembled structure 100 with one of the two identical roof support clips 30A installed so as to grip the upper edge region of the first sidewall component 60, and with the support arm 89A of the installed first roof support clip 30A positioned so the support arm 89A will underlie and support the lower region of the first roof component 80 when the first roof component 80 is moved to its assembled position (shown in FIG. 20) with the lower edge region of the first roof component 80 overlying the upper edge 62 of the first sidewall component 60.

It will be understood that, just as one of the two roof support clips 30A is installed to grip the upper edge region of the first sidewall component 60, the other of the two roof support clips 30A (not shown in FIG. 19) is installed in the same manner to grip the upper edge region of the second sidewall component 70, so the support arm 89A of the second roof support clip 30A is ready to underlie and support the lower edge region of the second roof component 90 when the second roof component 90 is moved to its assembled position with its lower edge region overlying the upper edge 72 of the second sidewall component 70.

In FIG. 19, new lines of icing 146, 156 are shown to have been applied to the inclined upper edges 46, 56 of the first and second end wall components, respectively, to engage and bond with opposite end regions of the interior surface 81 of the first roof component 80 when the first roof component 80 is positioned so the opposite end regions of its interior surface 81 overlie the inclined upper edges 46, 56 of the first and second end wall components 40, 50, respectively.

In FIG. 20, the completed structure 100 is shown with the first and second roof components 80, 90 moved into their assembled positions where the regions of their lower edges 82, 92 are underlaid and supported by the support arms 89A of the first and second roof support clips 30A that grip upper edge regions of the first and second sidewall components 60, 70, respectively.

As can also be seen in FIG. 20, the uppermost edges 82, 92 of the installed first and second roof components 80, 90, respectively, have corners that cooperatively engage to form a trough 95 that extends along the full lengths of the uppermost edges 82, 92 of the first and second roof components 80, 90, respectively. A small upper region of the roof components 80, 90 is broken away in FIG. 20 to show that icing 96 can be added to the trough 95 to extend along all, or only a part of the length of the trough 95.

### The New Elongate Bridging Clip 30B

The new bridging clip 30B shown in FIGS. 21-26 has substantially identical opposite end regions that duplicate significant portions of the improved roof support clip 30A to which FIGS. 8-13 are devoted. The numeral 32B designates an elongate central region of the bridging clip 30B that extends between and connects the two opposite end regions of the clip 30B.

In various ones of FIGS. 21-26, the numerals 31B, 33B, 34B, 35B, 36B, 38B and 39B indicate the same features as are indicated by the numerals 31A, 33A, 34A, 35A, 36A, 38A and 39A, respectively, in various ones of FIGS. 8-13. Accordingly, additional text need not be provided here, because the descriptions provided of the features of the roof clip 30A are the same as would be lengthy descriptions of the features of opposite end regions of the bridging clip 30B.

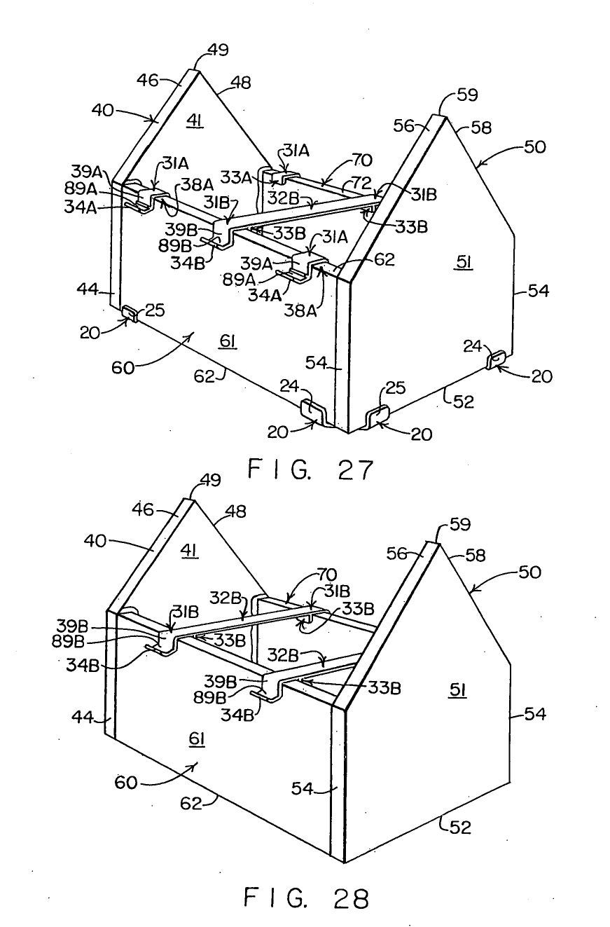

FIG. 27 is provided to illustrate that one of the new bridging clips 30B can be used in combination with a plurality of the new roof clips 30A to grip spaced upper portions of the two spaced-apart, parallel-extending sidewall components 50, 60. FIG. 28 is provided to show that a plurality of the new bridging clips 30B can be installed to grip spaced upper portions of the two spaced-apart, parallel-extending side wall components 50, 60, to maintain the desired parallel-extending assembled relationship of the upstanding sidewall components 50, 60.

As those who are skilled in the art will easily understand, almost any number of the roof clips 30A and the bridging clips 30B can be used together or in various combinations to support lower edge regions of roof components of a gingerbread structure, and to grip upper edge regions of two spaced-apart parallel-extending gingerbread components of a gingerbread structure, such as is indicated by the numeral 100B in FIGS. 27 and 28.

What FIG. 28 also illustrates is that, when one of more of the bridging clips 30B is used to grip upper edge regions of the upstanding sidewall components 60, 70, it may be unnecessary to use others of the substantially rigid clips described in the present application and in the aforementioned design, utility and provisional applications.

### About the Clips 20, 30A, 30B and the Set of Clips 10:

In one preferred embodiment, all of the substantially rigid clips 20, 30A, 30B are formed from non-edible plastic material—typically a thermoplastic material.

In an alternate preferred embodiment, the substantially rigid clips 20, 30A, 30B are formed from edible material such as hard candy—for example, such normally hard and relatively stiff and brittle candy as is often used to form peppermint candy sticks, candy canes, and the like.

Although the set of clips 10 shown in FIG. 1 includes six clips (as has been explained), those who are skilled in the art will readily understand that gingerbread structures that are within the scope and spirit of the present invention can be formed using other sets of substantially rigid clips (not shown) that may include fewer than, or more than, six clips.

Various reasons may be advanced for using a larger or smaller number of substantially rigid clips in building gingerbread structures. For example, a structure being assembled may utilize a larger or smaller number than four upstanding sidewall and end wall components (and may, therefore, need to utilize a different number of base clips to underlie and grip a lesser or greater number of corner regions), with the base clips being configured to match the mating angles required by overlapping edges of the upstanding wall components.

Likewise, a gingerbread structure being build may utilize a larger or smaller number of roof components (and may, therefore, need to utilize a different number of joints wherein the roof components overlie selected ones of the upstanding wall components).

Also, as those skilled in the art will readily appreciate, if gingerbread structures being constructed have longer roof joints (wherein the roof components of these structures overlie significantly longer upstanding sidewall components than are depicted in the accompanying drawings), it may be appropriate to use more than one of the roof support clips 30A and/or more than one of the bridging clips 30B at spaced locations along the lengthy roof joints to support the lower edge regions of the roof components.

The use of a greater or fewer number of the substantially rigid clips that are described in this application or in the referenced utility application will not cause the resulting structures to depart from the spirit and scope of the present invention.

If roof inclination angles of a gingerbread structure being constructed differ from that of the structure 100 shown in FIG. 20, the support arms 89A or 89B of the roof support clips 30A or 30B, respectively, will, in most instances, adequately underlie and support the lower edge regions of the overlying roof components. However, the configuration of the support arms 89A and 89B of the roof support clips 30A and 30B, respectively, can be modified, as may be needed, to work with such roof inclination angles as may be found in a gingerbread structure being constructed. Such modifications will not cause the roof support clips 30A, 30B, or the resulting gingerbread structures to deviate from the spirit and scope of the present invention.

### About the Deposits of Icing or Lines of Icing

In preferred practice, such icing as is applied to the structure 100 is preferably kept away from the clips 20, 30A, 30B—so that no icing, and no deposits or lines of icing are caused to overlie or otherwise obscure from view any of the clips 20, 30A, 30B. Making certain that no icing overlies any of the clips 20, 30A, 30B can be of importance, as a safety precaution, when the clips 20, 30A, 30B are formed from plastic materials that are, of course, inedible—so that the non-edible clips 20, 30A, 30B are not confused with nearby reaches of the edible icing.

However, if the clips 20, 30A, 30B are formed from edible material—such as, for example, hard candy of the type that is used to form candy canes and the like—permitting icing, or lines of icing, to overlie portions or all of the candy-formed clips 20, 30A, may be deemed to be acceptable, but is not preferred.

If desired, a line of icing 96 (a portion of which is shown in FIG. 20 where a portion of the roof of the structure 100 is broken away) can be applied to substantially fill the trough 95 that is cooperatively defined by the upper edges 82, 92 of the roof components 80, 90, respectively. Alternatively, small pieces of gingerbread (not shown) can be used to fill the trough 95, to completely hide the existence of the trough 95.

If short reaches of icing, or a line of icing 96 is applied to substantially fill the trough 95, such a line of icing will be exposed to view, which is inconsistent with all of the other lines of icing (such as are indicated by the numerals 144, 146, 156, 164 and 174) that are applied during assembly of the structure 100 so as to not show visibly to any significant degree when the structure 100 is completed.

### About the Baked Gingerbread Components 40-90:

Although the six baked gingerbread components 40-90 shown in FIG. 14 preferably have a substantially uniform thickness of about ⅜ inch to about 7/16 inch, other uniform thicknesses of baked gingerbread can be used, as a particular application may require, without departing from the spirit and scope of the present invention.

Although the baked gingerbread components that are disclosed herein preferably have a uniform thickness, gingerbread components that are not all of the same thickness can be utilized, in the event that clips such as those indicated by the numerals 20, 30A, 30B are provided that are capable of gripping the gingerbread components 40, 50, 60, 70, 80 and 90, wherever there is a need for the clips 20, 30A, 30B to do so. For example, the upstanding end wall components 40, 50 can be of one uniform thickness, while the upstanding sidewall components 60, 70, can be of a different uniform thickness, and the overlying roof components 80, 90, can be of still another uniform thickness.

Still other minor modifications to the configuration of the clips and to the configuration of the gingerbread components described herein will undoubtedly occur to those who are skilled in the art—and such minor modifications will not cause the clips, the gingerbread components, and/or the resulting gingerbread constructions to reside outside the spirit and scope of the present invention.

### About the Joints of Resulting Structures:

The structure 100 shown in FIG. 20 has many elongate joints formed between overlapping edge regions of various ones of the components 40, 50, 60, 70, 80, 90. Some of these elongate joints have lines of icing applied therealong to bond the adjacent components that form the elongate joints—and, some of these elongate joints do not have lines of icing applied therealong.

Here are some of the many observations that can be made regarding the elongate joints of the structure that are defined by pairs of adjacent gingerbread components such as are depicted in FIG. 14:

1) Some of the elongate joints of the structure 100 are underlaid, supported and/or connected ONLY BY CLIPS. These include the elongate roof joints that occur where the lower edge regions of the roof components 80 and 90 overlie the upper edges 62, 72 of the sidewall components 60, 70, respectively. No lines of icing extend along and bond the adjacent gingerbread components of either of these elongate joints.

2) Some of the elongate joints are connected ONLY BY LINES OF, OR BY SPACED DEPOSITS OF ICING. These include the four elongate roof joints defined where opposed upstanding edge regions of the roof components 80, 90, respectively, overlie the inclined upper edges 46, 48 and 56, 58 of the first and second end wall components 40, 50, respectively. No clips underlie or grip any of the gingerbread components 40, 50, 80 and 90 that form these elongate joints.

3) Some of the elongate icing-bonded joints are strengthened by clips installed on THE SAME JOINTS. These elongate joints include the four upstanding corner joints of the structure 100 which have the opposed, upstanding edges 44, 54 of the end wall components 40, 50, respectively, overlying the opposed upstanding edges 64, 74 of the sidewall components 60, 70, respectively. These four corner joints are underlaid by the base clips 10 that also grip the adjacent components 40,50 and 60,70 that define the four upstanding corner joints of the structure 100.

4) Some of the elongate icing-bonded joints are strengthened by clips applied ONLY TO NEARBY JOINTS. These include the four elongate roof joints where opposed edge regions of the roof components 80, 90, respectively, overlie the inclined upper edges 46,48 and 56,58 of the end wall components 40, 50, respectively.

5) Among the elongate joints of the structure 100 that DO HAVE lines of icing extending therealong (or that have spaced deposits of icing extending therealong) are the four upstanding corner joints of the structure 100; AND the four elongate roof joints where opposed edges 84, 94 of the roof components 80, 90, respectively, overlie the inclined upper edges 46,48 and 56,58 of the first and second end wall components 40 and 50, respectively.

6) Among the elongate joints of the structure 100 that DO NOT HAVE lines or spaced deposits of icing extending therealong are the two elongate roof joints where lower edge regions of the roof components 80 and 90 overlie the upper edges 62, 72 of the sidewall components 60, 70, respectively.

7) Among the elongate icing-bonded joints of the structure 100 that ARE ALSO CONNECTED BY CLIPS are the four upstanding corner joints of the structure 100. One of the base clips 10 underlies each of these four upstanding icing-bonded corner joints.

8) Among the elongate icing-bonded joints of the structure 100 that ARE NOT ALSO CONNECTED BY CLIPS are the four elongate roof joints that are defined by the opposed upwardly extending edge regions of the roof components 80 and 90 that overlie the inclined upper edges 46,48 and 56,58 of the end wall components 40, 50, respectively.

9) Among the elongate icing-bonded joints of the structure 100 that can be said to be strengthened by clips that are connected ONLY TO NEARBY ONES OF THE ELONGATE JOINTS, are the four elongate roof joints that are defined by opposed edge regions of the roof components 80 and 90 that overlie the inclined upper edges 46,48 and 56,58 of the end wall components 40, 50, respectively. These four elongate icing-bonded joints can be said to be at least partially strengthened by the roof support clips 30A that grip the upper edges 62, 72 of the sidewall components 60, 70, respectively, and have support arms 89A that underlie and support the lower edges 82, 92 of the roof components 80, 90, respectively.

Although the present invention has been described in a preferred form with particularity, it is understood that the present disclosure of the preferred form has been made only by way of example, and that numerous changes in the details of construction and the combination and arrangement of the clips and gingerbread components may be resorted to without departing from the spirit and scope of the invention.

What is claimed is:

1. A set of substantially rigid clips for connecting gingerbread components of a gingerbread structure formed from gingerbread components, with at least a first one of the clips of the set being configured to supportively underlie lower portions of an adjacent upstanding pair of the gingerbread components, and with a second one of the clips being configured to overlie upper portions of a non-adjacent pair of the gingerbread components.

2. The set of clips of claim 1 wherein each first one of the clips is configured to grip the lower portions of the adjacent upstanding pair of gingerbread components.

3. The set of clips of claim 1 wherein each second one of the clips is configured to grip the upper portions of the non-adjacent pair gingerbread components.

4. The set of clips of claim 1 wherein at least a chosen second one of the clips is also configured to underlie a gingerbread roof component of the gingerbread structure.

5. The set of clips of claim 1 wherein at least a selected one of the clips is configured to help retain one or more of the gingerbread components of the structure in a desired assembled orientation while at least one line of icing that extends along a specific joint of the structure defined by two engaged gingerbread components of the structure sets up or hardens to bond the two engaged gingerbread components.

6. The set of clips of claim 5 wherein the specific joint is a corner joint of the gingerbread structure.

7. The set of clips of claim 5 wherein the specific joint is a roof joint defined by an upstanding gingerbread component and an inclined gingerbread roof component of the gingerbread structure.

8. The set of clips of claim 1 wherein the at least one second clip has an elongate central region that extends between a pair of opposite end regions of the at least one second clip that each are configured to grip an upper region of a different one of two spaced apart upstanding gingerbread components of the gingerbread structure.

9. The set of clips of claim 8 wherein the at least one second clip has at least one of its opposite end regions configured to underlie an associated one of two gingerbread roof components of the gingerbread structure.

10. The set of clips of claim 8 wherein the gingerbread structure is provided with at least two of the second clips, with each of the two second clips being configured to grip spaced portions of a same pair of upstanding gingerbread components of the gingerbread structure.

11. The set of clips of claim 1 wherein at least one of the clips of the set is formed from plastic material.

12. The set of clips of claim 1 wherein at least one of the clips of the set is formed from edible material.

13. A gingerbread structure formed from gingerbread components, with the structure also including at least a first substantially rigid clip that supportively underlies lower portions of an adjacent pair of the gingerbread components, and a second substantially rigid clip that overlies upper portions of a non-adjacent pair of the gingerbread components.

14. The gingerbread structure of claim 13 wherein the first one of the clips also grips the lower portions of the adjacent pair of gingerbread components.

15. The gingerbread structure of claim 13 wherein the second one of the clips also grips the upper portions of the non-adjacent pair of gingerbread components.

16. The gingerbread structure of claim 13 wherein a the second one of the clips also underlies a gingerbread roof component of the gingerbread structure.

17. The gingerbread structure of claim 13 wherein at least one of the first or second clips also helps to retain one or more of the gingerbread components of the structure in a desired assembled orientation while at least one line of icing that extends along a specific joint of the structure defined by two engaged gingerbread components of the structure sets up or hardens to bond the two engaged gingerbread components.

18. The gingerbread structure of claim 17 wherein the specific joint is a corner joint of the gingerbread structure.

19. The gingerbread structure of claim 17 wherein the specific joint is a roof joint of the gingerbread structure.

20. The gingerbread structure of claim 17 wherein the second clip has an elongate central region that extends between a pair of opposite end regions of the second clip that each are configured to grip an upper region of a different one of two spaced-apart upstanding gingerbread components of the gingerbread structure.

21. The gingerbread structure of claim 20 wherein opposite end regions are each configured to underlie one or more of gingerbread roof components of the structure.

22. The gingerbread structure of claim 20 wherein the gingerbread structure is provided with at least two of the second clips, with each of the two second clips being configured to grip spaced portions of a same pair of upstanding gingerbread components of the gingerbread structure.

23. The gingerbread structure of claim 13 wherein at least a chosen one of the clips is formed from nonedible material.

24. The gingerbread structure of claim 13 wherein at least a selected one of the clips is formed from edible material.

25. A clip configured to connect two gingerbread components of a gingerbread structure and to aid in holding at least one of the gingerbread components in a desired assembled orientation while a line of icing that extends along a joint defined by the engagement of a specific pair of the gingerbread components sets up or hardens to bond the two engaging components.

26. The clip of claim 25 configured to grip an edge region of a selected one of the gingerbread components of the gingerbread structure.

27. The clip of claim 25 configured to underlie an edge region of a chosen one of the gingerbread components of the gingerbread structure.

28. The clip of claim 25 configured to overlie an edge region of a specific one of the gingerbread components of the gingerbread structure.

29. The clip of claim 25 having an elongate central region that extends between two substantially identically configured opposite end regions.

30. The clip of claim 29 wherein each of the opposite end regions is configured to grip a different one of the gingerbread components, and is configured to also underlie a separate gingerbread roof component of the gingerbread structure.
